(19) United States
(12) Patent Application Publication
(10) Pub. No.: US 2018/0011241 A1
(43) Pub. Date: Jan. 11, 2018

(54) BACKLIGHT DEVICE AND LIQUID CRYSTAL DISPLAY DEVICE WITH THE SAME

(71) Applicant: Japan Display Inc., Tokyo (JP)

(72) Inventor: Ken SUGIYAMA, Tokyo (JP)

(21) Appl. No.: 15/643,770

(22) Filed: Jul. 7, 2017

(30) Foreign Application Priority Data
Jul. 8, 2016 (JP) 2016-136316
Jun. 1, 2017 (JP) 2017-109463

(51) Int. Cl. F21V 8/00

(52) U.S. Cl. CPC G02B 6/0083; G02B 6/0085; G02B 6/0068; G02B 6/0073

(57) ABSTRACT

According to one embodiment, a backlight device includes a case with a bottom having an opening, a light guide LG on the bottom and having an emission surface and an incidence surface, and a light source unit in the case, configured to apply light into the incidence surface. The light source unit includes a wiring board including wiring lines and light emitting devices each having a light-emitting surface opposing the incidence surface. The wiring board includes a mounting portion opposing the incidence surface while interposing the light-emitting devices therebetween, on which the light-emitting devices are mounted, and a lead-out portion extending from the mounting portion and led out to a rear surface side of the bottom through the opening.

### CROSS-REFERENCE TO RELATED APPLICATIONS

This application is based upon and claims the benefit of priority from Japanese Patent Applications No. 2016-136316, filed Jul. 8, 2016; and No. 2017-109463, filed Jun. 1, 2017, the entire contents of all of which are incorporated herein by reference.

### TECHNICAL FIELD OF THE INVENTION

Embodiments described herein relate generally to a backlight device and a display device comprising the same.

### BACKGROUND OF THE INVENTION

In recent years, liquid crystal display devices are widely used as a display device of smartphones, personal assistant devices (personal digital assistants) (PADs), tablet computers, vehicle-navigation systems, etc. In general, a liquid crystal display device comprises a liquid crystal panel and a backlight unit overlaid on the rear surface of the liquid crystal panel and illuminates the liquid crystal panel. The backlight device includes a reflective layer, a light guide, an optical sheet, a light source unit which irradiates light which enters the light guide, a case (bezel) in which these members are accommodated, etc. The light source unit includes a wiring board and a plurality of light sources, for example, light-emitting diodes (LEDs) mounted on the wiring board.

As LEDs, a side view type and top view type are known. In the side-view LED, the light-emitting surface is provided normal to the wiring board, whereas in the top-view LED, the light-emitting surface is provided to face the wiring board to be parallel thereto.

When using a side-view LED as the light source, the LED is arranged such that the light-emitting surface thereof faces with the incidence surface of the light guide and the wiring board is parallel to the emission surface of the light guide, that is, parallel to the display surface of the liquid crystal panel. Because of this structure, if the wiring board is widened to enable routing of a great number of wiring lines on the wiring board, the wiring board may easily interfere with the display area, thus making it difficult to narrow the frame of liquid crystal display device.

On the other hand, when using the top-view LED, the LED is arranged such that the light-emitting surface thereof faces with the incidence surface of the light guide and the wiring board is parallel to the incidence surface, that is, to extend along the thickness direction of the backlight device. If the width of the wiring board is widened to enable routing of a great number of wiring lines, the backlight device need to be thickened accordingly.

### SUMMARY

The present disclosure relates generally to a backlight device and a display device including the same.

In an embodiment, a backlight device is provided. The backlight device includes a case with a bottom including an opening; a light guide on the bottom and including an emission surface and an incidence surface cross to the emission surface; and a light source unit in the case and configured to apply light into the incidence surface of the light guide, the light source unit including a wiring board comprising a plurality of wiring lines and a plurality of light-emitting devices on the wiring board, each including a light-emitting surface opposing the incidence surface of the light guide, and the wiring board including a mounting portion opposing the incidence surface of the light guide, while interposing the light-emitting devices therebetween, on which the light-emitting devices are mounted, and a lead-out portion extending from the mounting portion and led out through the opening of the bottom to a rear surface side of the bottom, integrated as one body.

In another embodiment, a liquid crystal display device is provided. The liquid crystal display device includes a liquid crystal panel including a first substrate, a second substrate disposed to oppose the first substrate, and a liquid crystal layer between the first substrate and the second substrate; and a backlight device opposed to the first substrate, the backlight device including: a case with a bottom plate comprising an opening; a light guide on the bottom plate and including an emission surface and an incidence surface cross to the emission surface; and

a light source unit in the case and configured to apply light into the incidence surface of the light guide, the light source unit including a wiring board comprising a plurality of wiring lines and a plurality of light-emitting devices on the wiring board, each including a light-emitting surface opposing the incidence surface of the light guide, and the wiring board comprising a mounting portion opposing the incidence surface of the light guide, while interposing the light-emitting devices therebetween, on which the light-emitting devices are mounted, and a lead-out portion extending from the mounting portion and led out through the opening of the bottom to a rear surface side of the bottom.

Additional features and advantages are described herein, and will be apparent from the following Detailed Description and the figures.

### BRIEF DESCRIPTION OF THE DRAWINGS

FIG. 1 is a perspective view showing a liquid crystal display device of the first embodiment from a display surface side.

FIG. 2 is a perspective view showing the liquid crystal display device from a rear surface side.

FIG. 3 is a perspective view showing the rear surface side of the liquid crystal display device in the state where a main FPC is folded back and fixed.

FIG. 4 is an exploded perspective view of the liquid crystal display device.

FIG. 5 is an exploded perspective view of a backlight unit of the liquid crystal display device.

FIG. 6A is a perspective view showing a light source unit of the backlight unit.

FIG. 6B is a perspective view showing a light source unit of a backlight unit according to a modification.

FIG. 7 is a perspective view showing a light source side of the liquid crystal display device exploded along line A-A of FIG. 3.

FIG. 8 is an exploded perspective view showing the backlight unit of the liquid crystal display device of the second embodiment.

FIG. 9 is a perspective view showing the rear side of the liquid crystal display device according to the second embodiment.

### DETAILED DESCRIPTION

Various embodiments will be described hereinafter with reference to the accompanying drawings. In general, according to one embodiment, a backlight device comprises a case with a bottom comprising an opening, a light guide on the bottom and comprising an emission surface and an incidence surface cross to the emission surface, a light source unit in the case, configured to apply light into the incidence surface of the light guide. The light source unit comprises a wiring board comprising a plurality of wiring lines and a plurality of light-emitting devices on the wiring board, each comprising a light-emitting surface opposing the incidence surface of the light guide, and the wiring board comprises a mounting portion opposing the incidence surface of the light guide, while interposing the light-emitting devices therebetween, on which the light-emitting devices are mounted, and a lead-out portion extending from the mounting portion and led out through the opening of the bottom to a rear surface side of the bottom.

Note that the disclosure is presented for the sake of exemplification, and any modification and variation conceived within the scope and spirit of the invention by a person having ordinary skill in the art are naturally encompassed in the scope of invention of the present application. Furthermore, a width, thickness, shape, and the like of each element are depicted schematically in the figures as compared to actual embodiments for the sake of simpler explanation, and they do not limit the interpretation of the invention of the present application. Furthermore, in the description and Figures of the present application, structural elements having the same or similar functions will be referred to by the same reference numbers and detailed explanations of them that are considered redundant may be omitted.

### First Embodiment

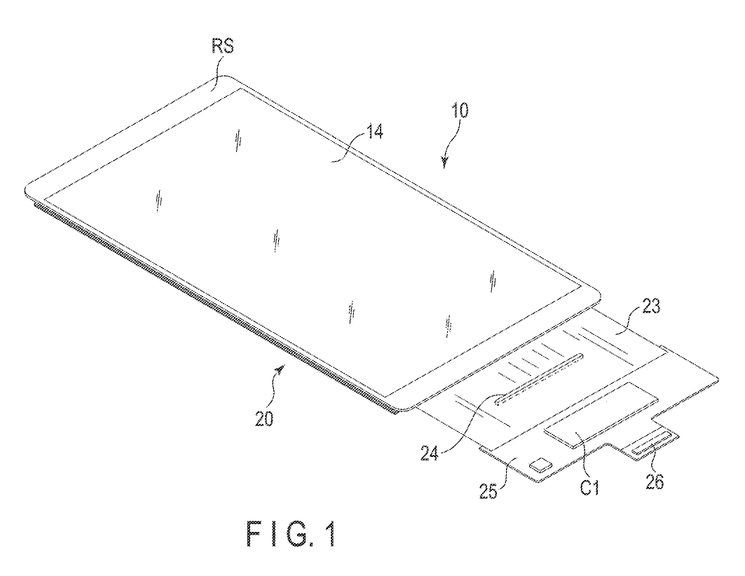

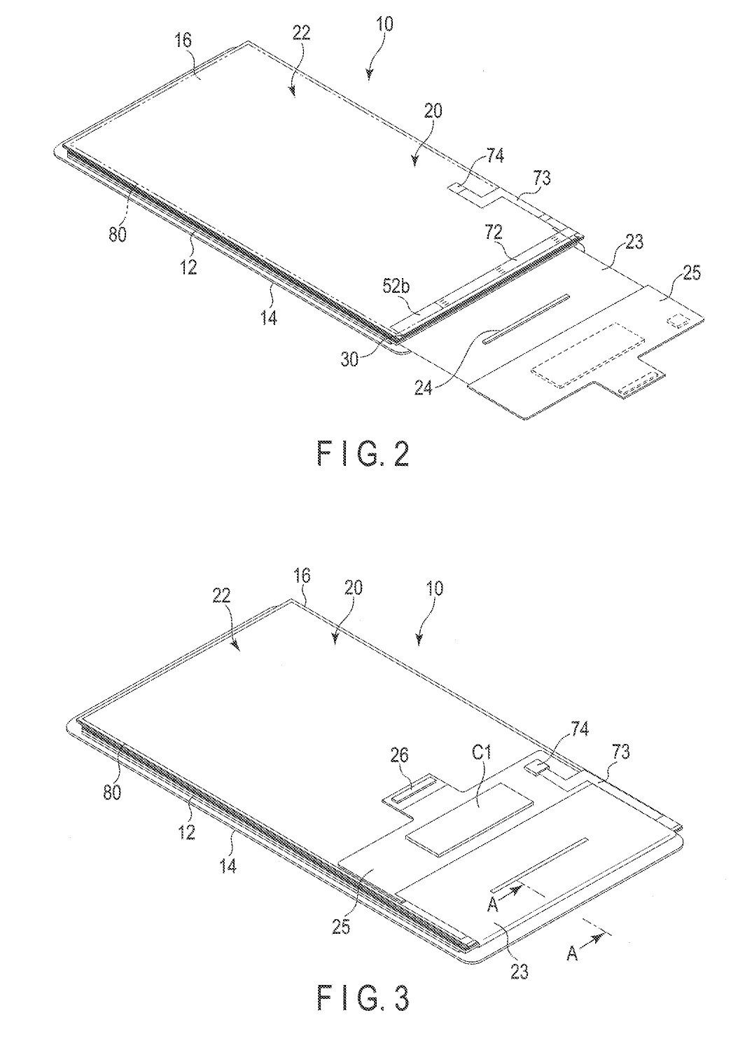

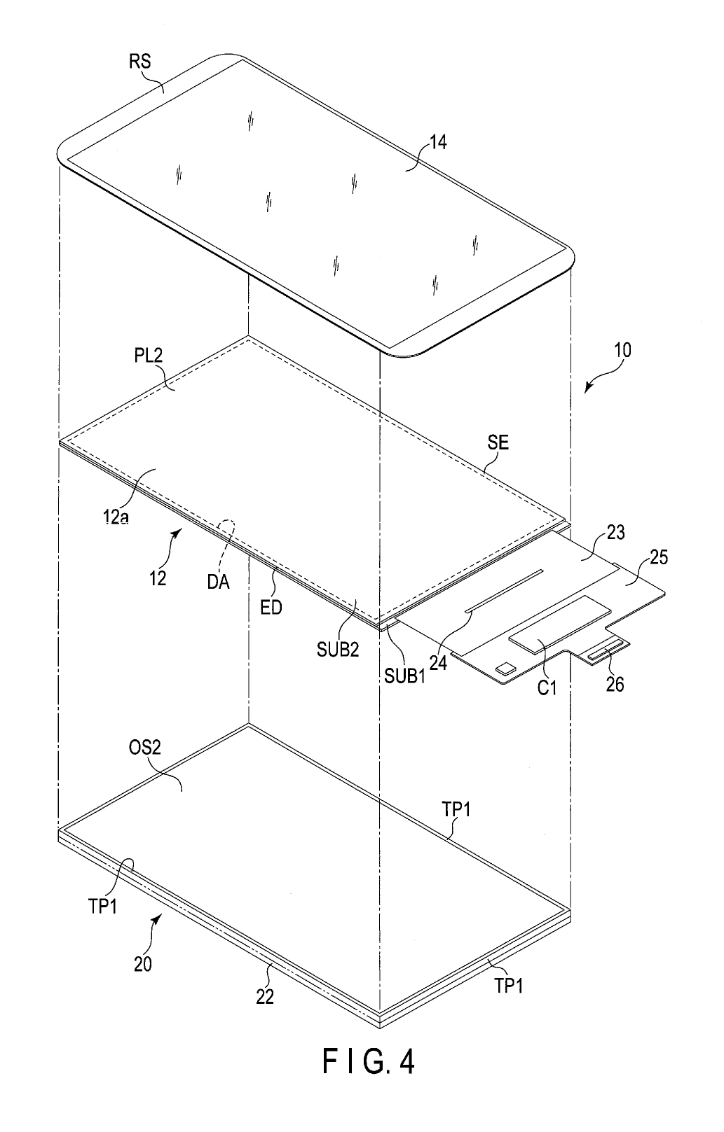

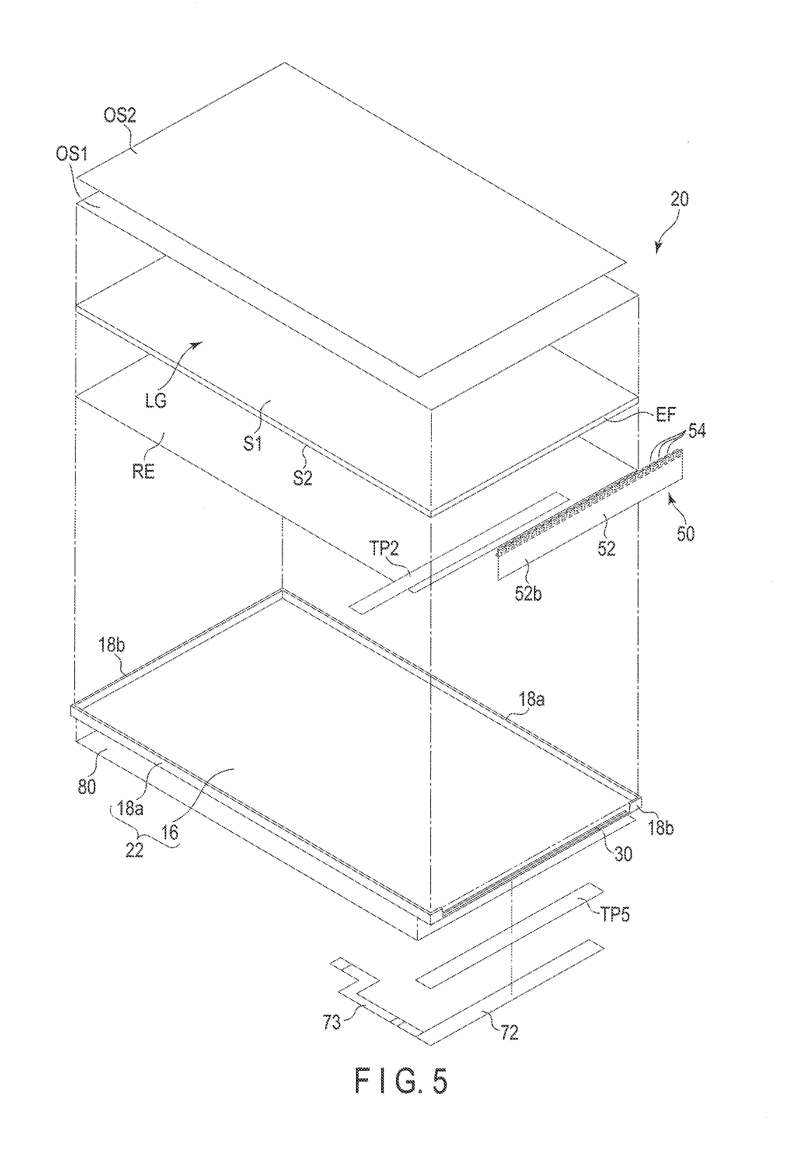

FIGS. 1 and 2 are perspective views showing a liquid crystal display device of the first embodiment as seen from a display surface side and a rear side, respectively. FIG. 3 is a perspective view showing the rear surface side of the liquid crystal display device in the state where the main FPC on which a driver IC is mounted is folded onto the rear surface side. FIG. 4 is an exploded perspective view of the liquid crystal display device.

A liquid crystal display device 10 can be incorporated into, for example, various kinds of electronic devices, such as smartphones, tablet computers, mobile phones, notebook PCs, portable game consoles, electronic dictionaries, television sets and car-navigation systems, to be used.

As shown in FIGS. 1, 2 and 4, the liquid crystal display 10 comprises an active-matrix flat liquid crystal panel 12, a transparent cover panel 14 overlaid on a display surface 12a, which is one flat surface of the liquid crystal panel 12 and configured to cover the entire display surface 12a and a backlight unit 20 as a backlight device, provided to face the rear surface, which is the other flat surface of the liquid crystal panel 12.

The liquid crystal panel 12 comprises a rectangular flat-plate first substrate SUB1, a rectangular flat-plate second substrate SUB2 disposed to oppose the first substrate SUB1 and a liquid crystal layer LQ held between the first substrate SUB1 and the second substrate SUB2. A circumferential portion of the second substrate SUB2 is attached to the first substrate SUB1 with a sealing member SE. On the surface of the second substrate SUB2, a polarizer PL2 is attached to form the display surface 12a of the liquid crystal panel 12. A polarizer PL1 is attached on a surface (a rear surface of the liquid crystal panel 12) of the first substrate SUB1.

In the liquid crystal panel 12, a rectangular display area (active area) DA is provided in a region inner side of the sealing member SE as the liquid crystal panel 12 is seen in plan view, to display images on the display area DA. A rectangular frame area ED is provided around the display area DA. The liquid crystal panel 12 comprises a transparent display function of displaying imaging by selectively transmitting the light from the backlight unit 20 to the display area DA. The liquid crystal panel 12 may have a structure supporting a lateral electric field mode which utilizes a lateral electric field along the main surface of the substrate mainly, or a structure supporting a vertical electric field mode which utilizes a vertical electric field crossing the main surface of the substrate mainly.

In the example illustrated, a flexible printed circuit board (main FPC) 23 is connected to a shorter side end of the first substrate SUB1 and extends from the liquid crystal panel 12 outward. On the main FPC 23, semiconductor devices including a driver IC 24 are mounted as signal supply sources which supply signals necessary to drive the liquid crystal panel 12. A sub-FPC 25 is joined to the extending end of the main FPC 23. On the sub-FPC 25, a capacitor C1, a connector 26 and the like are mounted. As shown in FIG. 3, the main FPC 23 and the sub-FPC 25 are folded over along a shorter-side end edge of the first substrate SUB1 and are arranged to be overlaid on a bottom of the backlight unit 20. As will be described later, the main FPC 23 and the sub-FPC 25 are adhered to the bottom of the backlight unit 20 with an adhesive such as a double-stick tape.

As shown in FIGS. 1 and 4, the cover panel 14 is formed into a rectangular plate shape from glass or an acrylic transparent resin, for example. The cover panel 14 has dimensions (width and length) greater than those of the liquid crystal panel 12 and an area greater than that of the liquid crystal panel 12 as seen in plan view (hereinafter, which refers to a state of viewing the liquid crystal panel from a direction normal to the display surface of the liquid crystal panel). The lower surface (rear surface) of the cover panel 14 is adhered to the display surface 12a of the liquid crystal panel 12 with an adhesive layer made from a transparent adhesives or adhesive, for example, and covers the entire display surface 12a. The periphery of the cover panel 14 projects outwards from the outer circumference of the liquid crystal panel 12 when the state where the cover panel 14 is attached to the liquid crystal panel 12 is seen in plan view. Each long side of the cover panel 14 and each respective long side of the liquid crystal panel 12 are substantially parallel to each other with a predetermined gap therebetween. Each short side of the cover panel 14 and each short side of the liquid crystal panel 12 are substantially parallel to each other with a predetermined gap therebetween. In this embodiment, the gap between each long side of the cover panel 14 and each respective long side of the liquid crystal panel 12, i.e., the width of the longer-side peripheral portion of the cover panel 14 is smaller than the gap between each short side of the cover panel 14 and each respective side of the liquid crystal panel 12, i.e., the width of the shorter-side peripheral portion of the cover panel.

On the lower surface (rear surface, surface on a liquid crystal side) of the cover panel 14, a frame-shaped light-shielding layer RS is formed. In the cover panel 14, a region other than the region which opposes the display area DA of the liquid crystal panel 12 is shielded by the light-shielding layer RS. The light-shielding layer RS may be formed on the upper surface (outer surface) of the cover panel 14. Note that the cover panel 14 may be omitted according to the use status of the liquid crystal display device 10.

The backlight unit 20 comprises a flat rectangular case 22 and an optical member and a light source unit installed or arranged in the case 22. The backlight unit 20 is disposed to oppose the rear surface of the liquid crystal panel 12 and attached to the rear surface of the liquid crystal panel 12, that is, for example, the polarizer PL1 with a frame-shaped adhesive member, for example, a double-stick tape TP1.

Next, the backlight unit 20 will be described in more detail.

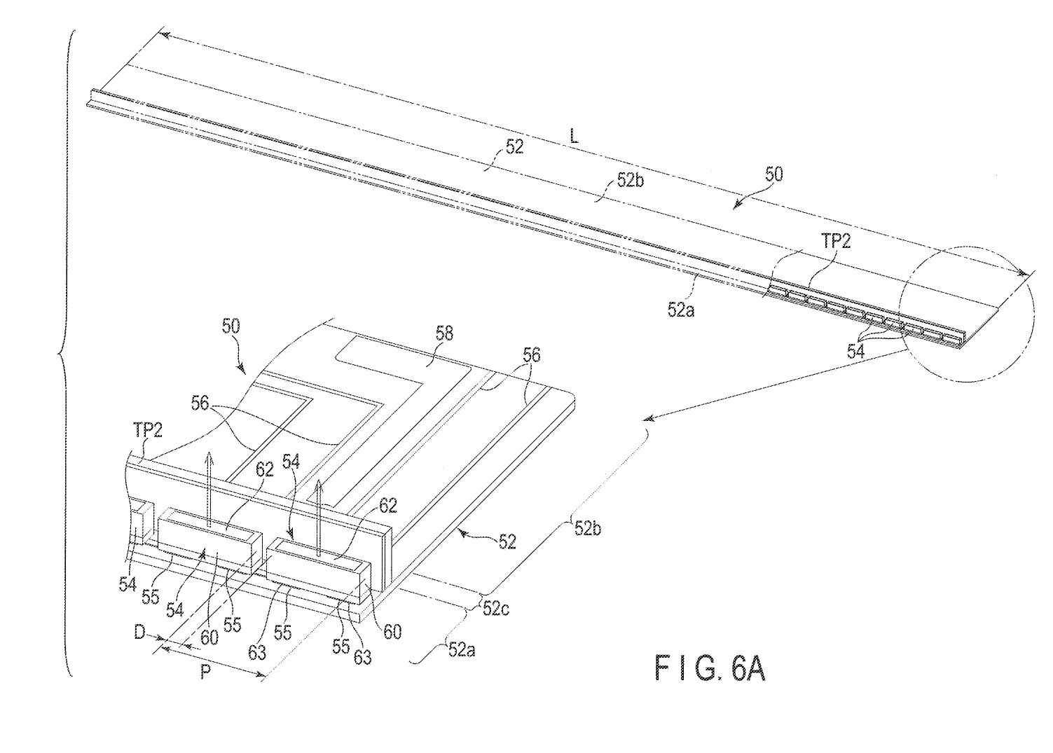

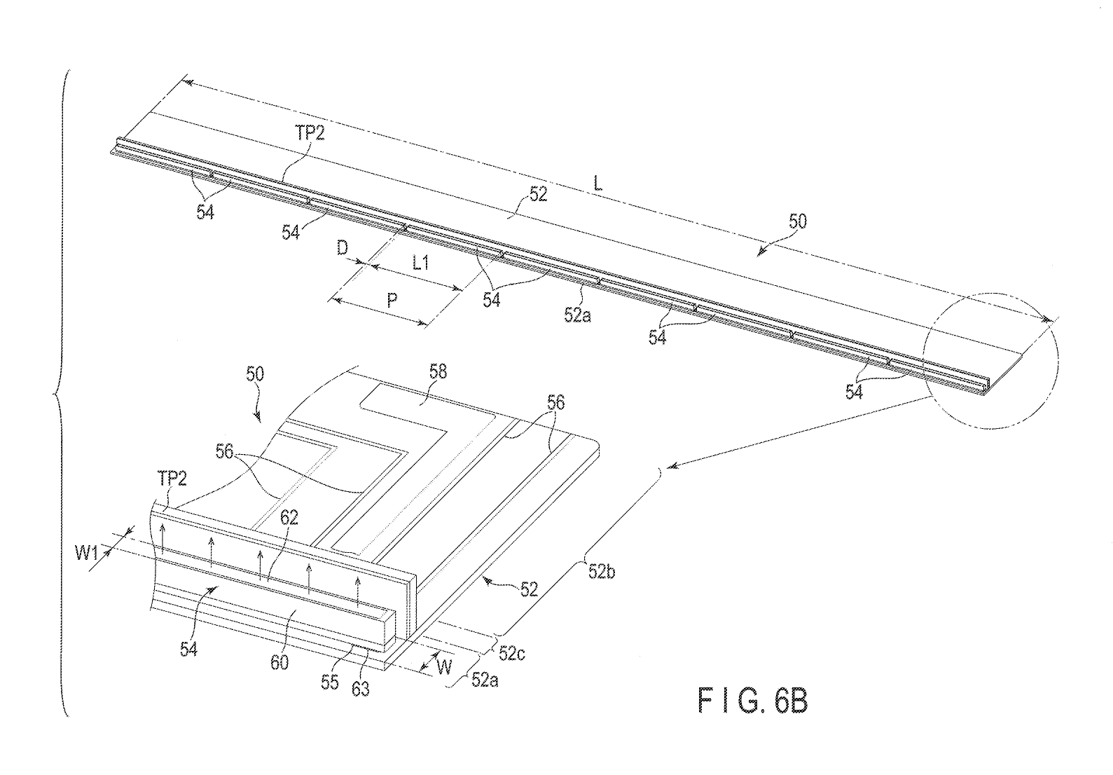

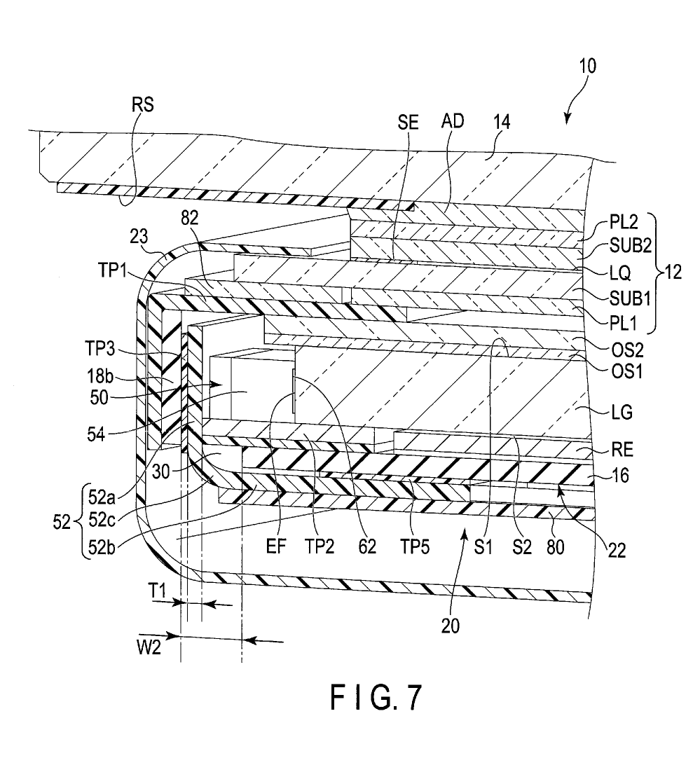

FIG. 5 is an exploded perspective view of the backlight unit 20. FIG. 6A includes perspective views of the light source unit, each including a partially expanded view thereof. FIG. 7 is an exploded perspective view showing the light-source side portion of the liquid crystal display device.

As shown in FIG. 5, the backlight unit 20 comprises a flat rectangular case (bezel) 22, a plurality of optical members arranged in the case 22, and the light source unit 50 which supplies the light which enters into the optical members.

The case 22 is formed into a flat rectangular lid by, for example, bending or press-molding a stainless plate material having a thickness of 0.1 mm. The case 22 includes a rectangular bottom 16, a pair of long-side walls 18a and a pair of short-side walls 18b, formed to stand on side edges of the bottom 16 and integrated as one body. In this embodiment, the bottom 16 is formed flat without uneven projections and recesses. As seen in plan view, the bottom 16 is formed slightly larger in the dimensions (length, width) of the first substrate SUB1 of the liquid crystal panel 12, and also smaller than the dimensions of those of the cover panel 14.

The long-side walls 18a are formed to stand substantially perpendicular to the bottom 16 and extend over the long sides of the bottom 16 in full length. The short-side walls 18b are formed to stand substantially perpendicular to the bottom 16 and extend over the long sides of the bottom 16 in full length. The height of these side walls 18a and 18b from the bottom 16 is, for example, about 1 mm.

As shown in FIGS. 5 and 7, the bottom 16 has slits 30 as openings. The slits 30 are formed near one short side of the bottom 16 to extend along the short side over substantially full length. A width W1 of the slits 30 is greater than a thickness W2 of the wiring board 52.

The backlight unit 20 comprises, as optical members, a reflective sheet RE having a rectangular shape as seen in plan view, a light guide LG, a plurality of, for example, two first optical sheets OS1 and second optical sheets OS2. The number of optical sheets is not limited to two, but three or more sheets may be used.

The reflective sheet RE has outer dimensions substantially equal to the inner dimensions of the bottom 16. The reflective sheet RE is provided on the bottom 16 and covers substantially the entire surface of the bottom 16 except for the slits 30. The reflective sheet RE has a thickness of 200 μm or less, preferably, 50 to 90 μm and a reflectivity of 90% or higher, preferably, 95% or higher.

The rectangular light guide LG comprises a first main surface S1 functioning as an emission surface, a second main surface S2 on an opposite side to the first main surface S1 and a plurality of side surfaces. In this embodiment, one side surface on a short side of the light guide LG is the incidence surface EF. The light guide LG has, for example, a thickness of about 0.23 to 0.32 mm. Moreover, the light guide LG is formed from, for example, a resin such as polycarbonate, an acrylic or silicon resin.

The light guide LG has outer dimensions (length and width) slightly smaller than the inner dimensions of the case 22 and slightly larger than the display area DA of the liquid crystal panel 12 as seen in plan view. The light guide LG is accommodated in the case 22 and placed on the reflective sheet RE while the second main surface S2 opposes the reflective sheet RE. Thereby, the first main surface (emission surface) S1 is located substantially parallel to the bottom 16 and the incidence surface EF is located substantially perpendicular to the bottom 16. The incidence surface EF is placed to oppose the short-side wall 18b with a slight gap therebetween.

According to this embodiment, as a first optical sheet OS1 and a second optical sheet OS2, for example, a light-transmissive diffusion sheet formed from a synthetic resin such as polyethylene terephthalate and a prism sheet are employed. The first optical sheet OS1 is formed into a rectangular shape having outer dimensions slightly larger (longer) than the outer dimensions of the light guide LG. The first optical sheet OS1 is overlaid on the first main surface S1 of the light guide LG. A short-side end of the first optical sheet OS1 projects towards the light source unit 50 side over the light guide LG. The second optical sheet OS2 is overlaid on the first optical sheet OS1.

As shown in FIG. 6A, the light source unit 50 comprises, for example, a slender belt-like wiring board 52 and a plurality of light sources mounted in lines on the wiring board 52. As light sources, light-emitting devices, for example, light-emitting diodes (LEDs) 54 are employed.

A flexible printed circuit board (FPC) is used for the wiring board 52. That is, the wiring board 52 includes an insulating base formed from polyimide or the like and a conductive layer such as a copper foil, formed on the insulating base. The conductive layer is patterned to form a plurality of contact pads 55, wiring lines 56 and heat transfer patterns (heat transfer layer) 58.

A length L of the wiring board 52 is substantially equal to a length of the incidence surface EF and slightly shorter than the length of the slits 30 formed in the bottom 16. The wiring board 52 includes a belt-shaped mount portion (mounting region) 52a extending along one long side, a belt-shaped lead-out portion (wiring region) 52b extending from the mounting portion 52a to the other long side and a bent portion 52c curved at substantially right angles and located between the mounting portion 52a and the lead-out portion 52b, all integrated as one body.

The contact pads 55 are formed in the mounting portion 52a and are arranged along with a longitudinal direction of the mounting portion 52a. The wiring lines 56 extend respectively from the contact pads 55 to the lead-out portions 52b and are routed on the lead-out portions 52b. The heat transfer patterns 58 are formed on the lead-out portions 52b, respectively to extend from near the mounting portion 52a to the long-side end of the lead-out portion 52b. Further, each heat transfer pattern 58 should preferably be formed so that a LED 54 side thereof is narrow in width and a lead-out portion 52b side thereof is broad. Each heat transfer pattern 58 is electrically dissociated from the wiring lines 56 and the contact pads 55 and set in a floating state.

The LEDs 54 used here are each a top-view LED. Each LED 54 comprises a substantially rectangular parallelepiped case (package) 60 formed of a resin, for example. An upper surface of the case 60 forms the light-emitting surface 62 and a bottom surface of the case 60, which is located on an opposite side to the light-emitting surface 62, forms the mounting surface. A contact terminal 63 is formed on the bottom of the case 60.

As to each LED 54, the bottom of the case 60 is mounted on the mounting portion 52a, and thus the contact terminals 63 are electrically connected to the contact pads 55. The light-emitting surface 62 of the LED 54b is set substantially parallel to the wiring board 52, and the LED 54 emits light from the light-emitting surface 62 along a direction substantially perpendicular to the wiring board 52.

The LEDs 54 are mounted on the mounting portion 52a so that the longitudinal direction of the case 60 is aligned with the longitudinal direction of the mounting portion 52a. In this embodiment, the light source unit 50 includes, for example, thirty to fifty LEDs 54, the number of which may vary according to the width of the display area DA. The LEDs 54 are arranged in one row on the mounting portion 52a from one longitudinal end to the other end of the mounting portion 52a.

Note that in this embodiment, an arrangement pitch P of the LEDs 54 is set to about 1.1 to 1.5 times of the length L of each LED 54 in the aligning direction, and a gap D of each adjacent pair of LEDs 54 is set to about 10% to 50% of the length L. In this embodiment, the gap D between the LEDs 54 is set narrower than conventional cases, and thus the region of uneven brightness, which may be generated between each adjacent pair of light sources can be narrowed.

In this embodiment, a belt-like fixing tape TP2 for fixing and positioning each LED 54 is adhered onto a side surface of each LED 54. The fixing tape TP2 is used such that about a half of the region along a width direction is attached to each LED 54, and a remaining half of the region is attached to the light guide LG. One side edge of the fixing tape TP2 may abut on the wiring board 52. The fixing tape TP2 employed here is not limited to one continuous tape, but may be of a plurality of divided fixing tapes. Further, the fixing tape TP2 may be, black, for example, to have a light-shielding property.

The number of LEDs 54 mounted is not limited to thirty to fifty, but may be increased or decreased as needed. When LEDs longer than the length L1 are used, the number of LEDs to be mounted may be decreased. According to the modification shown in FIG. 6B, the length L1 of the LEDs 54 is set to about 4 to 5 times that of the LEDs 54 shown in FIG. 6A. The width W of the mounting portion 52a of the circuit board 52 is 1.1 to 1.5 times the width W1 of the LEDs 54. The arrangement pitch P of the LEDs 54 is set to about 1.1 to 1.5 times the length L1 of the LEDs 54, and the gap D between adjacent pairs of LEDs 54 is about 10% to 50% of the length L1 of the LEDs 54.

As shown in FIGS. 5 and 7, the light source unit 50 configured as described above is accommodated in the case 22. The mounting portion 52a and the LEDs 54 are arranged between the incidence surface EF of the light guide LG and the side wall 18b. The light-emitting surfaces 62 of the LEDs 54 oppose or abut against the incidence surface EF of the light guide LG. The mounting portion 52a is attached to the inner surface of the side wall 18b by an adhesive, for example, a double-stick tape TP3. Note that the adhesive is not limited to the double-stick tape TP3, but, for example, a UV-curing adhesives can be used as well. The light emitted from the LEDs 54, since it contains light of an ultraviolet region, can cure the UV-curing adhesives with this ultraviolet ray.

The fixing tape TP2 is adhered to the side surfaces of all the LEDs 54 (the side surface of the case 22 on a bottom 16 side) and the second main surface S2 of the light guide LG. The LEDs 54 are positioned with respect to the light guide LG and fixed there with the fixing tape TP2. Thus, the light-emitting surfaces 62 are maintained to abut against the edge face of the light guide LG, i.e., the incidence surface EF.

The light source-side ends of the first optical sheet OS1 and the second optical sheet OS2 extend from the light guide LG to a position which opposes the LEDs 54.

As shown in FIGS. 5 and 7, the bent portion 52c and the lead-out portion 52b of the wiring board 52 penetrate the slits 30 to lead out from the rear side of the bottom 16. The bent portion 52c is curved or bent at substantially 90 degrees to a bottom 16 side. Thus, as shown in FIGS. 2 and 7, the lead-out portion 52b is adjacent to and opposes the rear surface of the bottom 16, and adhered to the bottom 16 with the double-stick tape TPS.

As mentioned above, the width W2 of the slits 30 to which the wiring board 52 penetrates is greater than the thickness T1 of the wiring board 52, for example, two times the thickness T1 or more. Therefore, by bending the wiring board 52 at a position of the bending portion 52c, the wiring board 52 can be bent at a comparatively great curvature without interfering with the bottom 16, thereby suppressing the disconnection of the wiring lines 56 on the wiring board 52, which may be caused by the bending. Furthermore, the mounting portion 52a is fixed to the side wall 18b with the fixing tape TP3. Thus, when bending the wiring board 52 at a lower end of the fixing tape TP3 as a fulcrum, the bending portion 52c can be provided at an appropriate position.

As shown in FIG. 2, on the rear surface side of the bottom 16a, a connection FPC 72 is fixed on the lead-out portion 52b to be electrically connected to the wiring lines. The connection FPC 72 includes a connection portion 73. A connector 74 is provided at the extending end of the connection portion 73.

As shown in FIGS. 2, 3 and 7, the backlight unit 20 may comprise a heat-radiating sheet 80 provided on a rear surface side of the case 22. The heat-radiating sheet 80 is formed from, for example, a highly heat conductive material such as graphite. The heat-radiating sheet 80 has a rectangular shape of dimensions substantially equal to those of the bottom 16. The heat-radiating sheet 80 is overlaid on the lead-out portion 52b and the rear surface of the bottom 16 to cover the lead-out portion 52b and substantially the entire surface of the bottom 16. The heat-radiating sheet 80 may be adhered to the bottom 16 with an adhesive material (not shown). The heat-radiating sheet 80 is thermally connected to the wiring lines 56 and the heat transfer pattern 58 provided in the lead-out portion 52b. Thus, the heat-radiating sheet 80 extends to cover from the short side on a light source unit side of the bottom 16 over to the short side on an opposite side.

The heat generated by the light emission of the LEDs 54 propagates to the heat-radiating sheet 80 through the wiring board 52, mainly, through the wiring lines 56 and the heat transfer pattern 58, and further, from the heat-radiating sheet 80 to the bottom 16 to radiate heat from the heat-radiating sheet 80 and the bottom 16.

The backlight unit 20 configured as described above is adhered to the rear surface of the liquid crystal panel 12 with the frame-shaped double-stick tape TP1. As shown in FIGS. 4 and 7, the double-stick tape TP1 is adhered to the end edges of the side walls 18a and 18b and the outer circumferential portion of the second optical sheet OS2. A part of the double-stick tape TP1 is bent to extend toward the bottom 16 and adhered to an outer surface of the side wall 18b on the light source side.

Further, on a liquid crystal panel 12 side, the double-stick tape TP1 is adhered to the circumferential portion of the polarizer PL1 and the circumferential portion of the first substrate SUB1, which interpose a spacer 82 therebetween.

As shown by two dots and dashed lines in FIG. 4, the double-stick tape TP1 may be adhered also to the outer surfaces of the side walls 18a and the other side wall 18b.

As shown in FIGS. 3 and 7, the main FPC 23 and the sub-FPC 25 extending from the liquid crystal panel 12 are folded over to the rear side of the bottom 16 along with the side wall 18b. The main FPC23 and the sub-FPC 25 are adhered to the heat-radiating sheet 80 or the bottom 16 with an adhesive material (not shown). Further, the connector 74 of the connection FPC 72 is connected to a connection portion on the sub-FPC 25.

According to the liquid crystal display device 10 configured as described above, the wiring board 52 includes the mounting portion 52a on which the LEDs 54 are mounted and the lead-out portion 52b provided continuously from the mounting portion 52a. A plurality of wiring lines 56 are formed on the lead-out portion 52b. By using the lead-out portion 52b as an installation space of the wiring lines 56, it becomes possible to easily route a great number of wiring lines. As a result, more LEDs 54 can be mounted on the mounting portion 52a. Moreover, the lead-out portion 52b is lead out through a slit 30 formed in the bottom 16 to the rear surface side of the bottom 16. Only the mounting portion 52a is accommodated in the case 22. With this structure, the wiring board 52 does not interfere with the bottom 16 of the case 22, the bottom 16 is formed flat, and the case 22 and the backlight unit 20 can be thinner.

The lead-out portion 52b is adhered to the bottom 16. Thus, the heat generated from the light source (the LEDs 54) can be transmitted to the bottom 16, which is a metal having a high heat capacity, through the wiring board 52 and then can be thermally dispersed. Furthermore, in this embodiment, the heat-radiating sheet 80 is overlaid on the lead-out portion 52b and the bottom 16. The heat generated from the LEDs 54 is transmitted to the heat-radiating sheet 80 and then radiated from the heat-radiating sheet 80 to the outside or the bottom 16. Thus, it is possible to prevent the light source of the backlight unit 20 from increasing the temperature to high regionally, thus dispersing the heat in the entire backlight unit 20. Furthermore, the heat transfer pattern 58 is provided in the lead-out portion 52b and thus the heat from the light source can be more efficiently transferred to the bottom 16 and the heat-radiating sheet 80.

As described above, according to this embodiment, a backlight unit which can be further thinned and whose frame can be further narrowed, and a liquid crystal display device comprising the backlight unit can be obtained.

Next, a backlight unit of a liquid crystal display device according to another embodiment will be described. In the embodiment described below, the same structural parts as those of the above-described embodiment will be designated by the same referential symbols, and detailed descriptions therefor will be omitted or abbreviated. Mainly, different aspects from those of the embodiment will be explained in detail.

### Second Embodiment

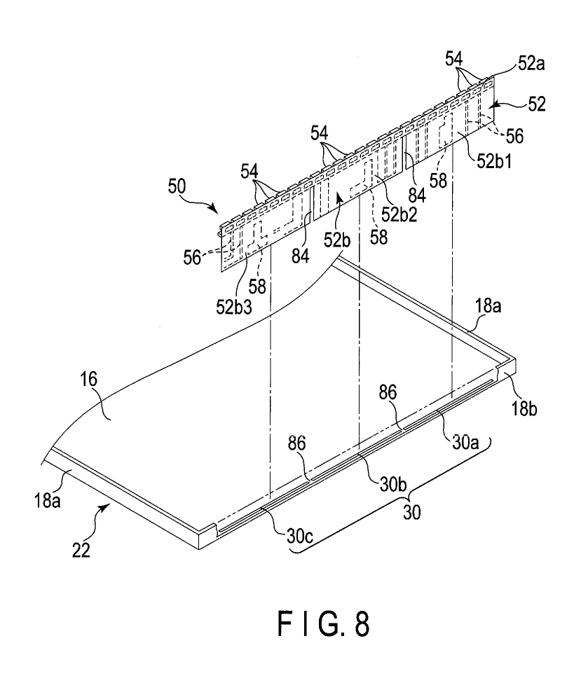

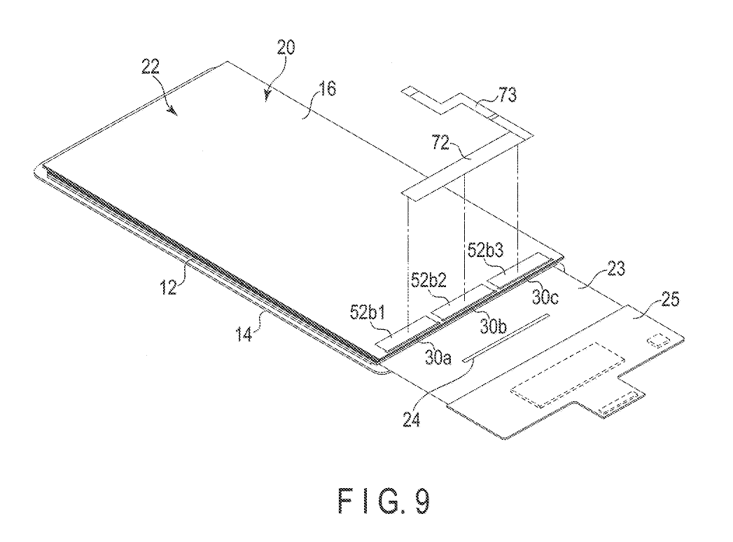

FIG. 8 is an exploded perspective view showing a case and a light source unit of a backlight unit according to the second embodiment and FIG. 9 is a perspective views showing a rear surface side of the liquid crystal display device according to a modification of the second embodiment.

As shown in FIG. 8, according to the second embodiment, a plurality (for example, two) of slits 84 are formed in a lead-out portion 52b in a wiring board 52. Each slit 84 extends from one side edge of the lead-out portion 52b to the vicinity of the mounting portion 52a along the width direction of the wiring board 52. The lead-out portion 52b is divided by the two slits 84 into three, a first region 52b1, a second region 52b2 and a third regions 52b3. In each of the regions 52b1, 52b2 and 52b3, a plurality of wiring lines 56 and a floating heat transfer pattern 58 are formed.

The bottom 16 of the case 22 comprises a plurality (for example, two) of bridges 86 each extending across the slits 30. The bridges 86 are provided at positions corresponding to the slits 84. The slit 30 of the bottom 16 is divided by the two bridges 86 into three slits 30a, 30b and 30c. The three slits 30a, 30b and 30c are each formed slightly longer than the length of the regions 52b1, 52b2 and 52b3. Moreover, the three slits 30a, 30b and 30c each have a width greater than the thickness of the wiring board 52.

As shown in FIGS. 8 and 9, the regions 52b1, 52b2 and 52b3 are penetrated through the slits 30a, 30b, and 30c respectively, and are lead out from the rear surface side of the bottom 16. Simultaneously, the bridges 86 pass through the slits 84 respectively. Further, the regions 52b1, 52b2 and 52b3 are bent towards the rear surface side of the bottom 16 to oppose the bottom 16 and attached thereto with a fixing tape.

A connection FPC 72 is overlaid on the region 52b1, 52b2 and 52b3. Wiring lines of the connection FPC 72 are electrically connected to a plurality of wiring lines provided in the regions 52b1, 52b2 and 52b3.

The other structures of the backlight unit 20 and the liquid crystal display device 10 are similar to those of the backlight unit and the liquid crystal display device of the previously described embodiment.

According to the second embodiment configured as above, the bridges 86 are provided across the slits 30 and therefore the mechanical strength of each of the bottom 16 and the case 22 can be enhanced. Further, also in the second embodiment, an advantageous effect similar to that of the first embodiment described above can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Note that all the structures which can be carried out by any modification and variation conceived within the scope and spirit of the invention by a person having ordinary skill in the art based on each structural elements described in the embodiments are naturally encompassed in the scope of invention of the present application. Further, regarding the present embodiments, any advantage and effect which would be obvious from the description of the specification or arbitrarily conceived by a skilled person are naturally considered achievable by the present invention.

The outer and inner shapes of the structural members of the display panel and backlight unit are not limited to rectangular, but one or both of the outer and inner shapes may be polygonal, circular, elliptical or combination of any of these as seen in plan view. The materials of the structural members of the display device are not limited to those described in the example provided above, but may be selected from various types.

What is claimed is:

1. A backlight device comprising:
a case with a bottom comprising an opening;
a light guide on the bottom and comprising an emission surface and an incidence surface cross to the emission surface; and
a light source unit in the case and configured to apply light into the incidence surface of the light guide,
the light source unit comprising a wiring board comprising a plurality of wiring lines and a plurality of light-emitting devices on the wiring board, each comprising a light-emitting surface opposing the incidence surface of the light guide, and
the wiring board comprising a mounting portion opposing the incidence surface of the light guide, while interposing the light-emitting devices therebetween, on which the light-emitting devices are mounted, and a lead-out portion extending from the mounting portion and led out through the opening of the bottom to a rear surface side of the bottom, integrated as one body.

2. The backlight device of claim 1, wherein
the opening of the bottom is a slit having a width greater than a thickness of the wiring board.

3. The backlight device of claim 1, wherein
a region of the bottom, which opposes at least the light source unit, is formed flat.

4. The backlight device of claim 2, wherein
the wiring board comprises a curved bent portion located between the mounting portion and the lead-out portion, and
a width of the slit is equal to or greater than a width of the bent portion.

5. The backlight device of claim 1, wherein the lead-out portion is attached to a rear surface of the bottom.

6. The backlight device of claim 4, wherein
the case comprises a plurality of side walls standing along a circumferential edge of the bottom,
the mounting portion of the wiring board is attached to an inner surface of one of the side walls with an adhesive, and
the bent portion is bent at the adhesive as a fulcrum.

7. The backlight device of claim 1, further comprising:
a heat-radiating sheet overlaid on the lead-out portion of the wiring board and the bottom.

8. The backlight device of claim 7, wherein
the heat-radiating sheet extends from one end on a side of the light source unit to an other end on an opposite side in the bottom.

9. The backlight device of claim 7, wherein
the wiring board comprises a plurality of wiring lines connected to the light-emitting devices and extending from the mounting portion to the lead-out portion, and a heat-transfer layer electrically independent from the wiring lines and extending from the mounting portion to the lead-out portion.

10. The backlight device of claim 9, wherein
the heat transfer layer is formed from a conductive layer same as that of the wiring lines.

11. A liquid crystal display device comprising:
a liquid crystal panel comprising
a first substrate, a second substrate disposed to oppose the first substrate, and a liquid crystal layer between the first substrate and the second substrate; and
a backlight device opposed to the first substrate,
the backlight device comprising:
a case with a bottom plate comprising an opening;
a light guide on the bottom plate and comprising an emission surface and an incidence surface cross to the emission surface; and
a light source unit in the case and configured to apply light into the incidence surface of the light guide,
the light source unit comprising a wiring board comprising a plurality of wiring lines and a plurality of light-emitting devices on the wiring board, each comprising a light-emitting surface opposing the incidence surface of the light guide, and
the wiring board comprising a mounting portion opposing the incidence surface of the light guide, while interposing the light-emitting devices therebetween, on which the light-emitting devices are mounted, and a lead-out portion extending from the mounting portion and led out through the opening of the bottom to a rear surface side of the bottom.

12. The liquid crystal display device of claim 11, wherein
the opening of the bottom is a slit having a width greater than a thickness of the wiring board.

13. The liquid crystal display device of claim 11, wherein
a region of the bottom, which opposes at least the light source unit, is formed flat.

14. The liquid crystal display device of claim 12, wherein
the wiring board comprises a curved bent portion located between the mounting portion and the lead-out portion, and
a width of the slit is equal to or greater than a width of the bent portion.

15. The liquid crystal display device of claim 11, wherein the lead-out portion of the wiring board is attached to a rear surface of the bottom.

16. The liquid crystal display device of claim 14, wherein
the case comprises a plurality of side walls standing along a circumferential edge of the bottom,
the mounting portion of the wiring board is attached to an inner surface of one of the side walls with an adhesive, and
the bent portion is bent at the adhesive as a fulcrum.

17. The liquid crystal display device of claim 11, further comprising:
a heat-radiating sheet overlaid on the lead-out portion of the wiring board and the bottom.

18. The liquid crystal display device of claim 17, wherein
the heat-radiating sheet extends from one end on a side of the light source unit to an other end on an opposite side in the bottom.

19. The liquid crystal display device of claim 17, wherein
the wiring board comprises a plurality of wiring lines connected to the light-emitting devices and extending from the mounting portion to the lead-out portion, and a heat-transfer layer electrically independent from the wiring lines and extending from the mounting portion to the lead-out portion.
